(19) United States
(12) Patent Application Publication
(10) Pub. No.: US 2012/0009120 A1
(43) Pub. Date: Jan. 12, 2012

(54) THERMAL CRACKING RESISTANT ZEOLITE MEMBRANE AND METHOD OF FABRICATING THE SAME

(75) Inventors: CHURL-HEE CHO, Daejeon (KR); Jeong-Gu Yeo, Daejeon (KR); Young-Soo Ahn, Daejeon (KR); Si-Kyung Kim, Daejeon (KR); Joon-Soo Kim, Daejeon (KR); Nam-Jo Jeong, Daejeon (KR); Bo-Yun Jang, Daejeon (KR); Dong-Kook Kim, Daejeon (KR); Hong-Soo Kim, Daejeon (KR)

(73) Assignee: KOREA INSTITUTE OF ENERGY RESEARCH, Daejeon-Si (KR)

(21) Appl. No.: 12/843,159

(22) Filed: Jul. 26, 2010

(30) Foreign Application Priority Data
Jul. 6, 2010 (KR) 10-2010-0065091

(51) Int. Cl. C01B 39/02

(52) U.S. Cl. 423/709

(57) ABSTRACT

The present disclosure relates to a thermal cracking resistant zeolite membrane and a method of fabricating the same. The method includes dissolving an alumina-based material, a silica-based material and sodium hydroxide in water to prepare an aqueous solution, stirring the aqueous solution to form a hydrothermal solution, preparing a slurry of zeolite seeds through wet-type vibration pulverization and centrifugal separation of zeolite powder, passing the zeolite seeds through a support by vacuum filtration such that the zeolite seeds can be infiltrated into an inner region of the support ranging from a depth of 3 μm to a depth corresponding to 50% of a total thickness of the support, and immersing the support into the hydrothermal solution for hydrothermal treatment to grow a dense zeolite separation layer not only on the surface of the support but also on the inner region thereof. The zeolite membrane prevents the occurrence of thermal cracking on the zeolite separation layer, thereby providing good thermal stability and separation performance during heating and at a target processing temperature.

### BACKGROUND OF THE INVENTION

1. Field of the Invention

The present invention relates to a thermal cracking resistant zeolite membrane and a method of fabricating the same. The present invention relates to a technique for providing stable and superior separation characteristics to a zeolite membrane by preventing the zeolite membrane from undergoing thermal cracking.

2. Description of the Related Art

Zeolites are materials having a periodic arrangement of uniform micro or meso-pores having a diameter of several to several dozen angstroms in a crystal structure, and aluminosilicate is a representative zeolite.

An aluminosilicate-based zeolite is a material in which some SiO₂ is substituted by Al₂O₃, and contains Na ions, the mole number of which is two times that of the substituted Al₂O₃ in order to maintain electrical neutrality.

For example, NaA zeolites are aluminosilicate minerals that have a three-dimensionally periodic arrangement of micropores having a diameter of 4 angstroms in a crystal structure. In the NaZ zeolite, one mole of SiO₂ is substituted by a half mole of Al₂O₃ and the mole number of Na ions contained in the NaZ zeolite is two times that of the substituted Al₂O₃ in order to maintain electrical neutrality.

The zeolites are widely used for catalysts, adsorbents, ion exchangers, and the like.

In recent years, zeolite membranes have been developed by introducing a zeolite separation layer of a thin film shape to a surface of a plate or pipe-shaped porous ceramic or metal support.

Here, the zeolite separation layer must be dense and free from pin holes, cracks and the like to exhibit good separation performance.

Such zeolite membranes are used for a process of separating particular materials or a membrane reaction process for enhancing synthesis of particular materials through hybridization with a catalyst in the field of energy, environment, chemistry, bio-technology, and the like, and attract considerable attention with an increase in utilization frequency and range thereof.

Examples of the zeolite membranes currently developed in the art include LAT, MFI, and FAU zeolite membranes, which include arrangements of micropores having diameters of 4 angstroms, 5.5 angstroms, and 7.4 angstroms, respectively.

In particular, reports say that a NaA zeolite membrane as one of LAT zeolite membranes and a NaY zeolite membrane as one of FAU zeolite membranes exhibit excellent solvent separation performance, such as separation of water/non-polar solvent, separation of polar solvent/non-polar solvent, etc., due to their uniform micropores and high polarity.

Further, it is expected that the NaA zeolite membrane and the NaY zeolite membrane will be used for gas separation relating to recovery of CO₂, H₂, and SF₆, methanol synthesis, selective CO oxidation membrane reaction, and the like.

However, zeolite separation layers of the NaA and NaY zeolite membranes tend to contract upon temperature increase, whereas the porous ceramic or metal support used as the supporters of the membranes tend to expand upon temperature increase, so that thermal cracking tends to occur in the zeolite separation layers when the zeolite separation layers are heated to a certain temperature for a target process. Hence, a thermal cracking resistant zeolite membrane and a method of fabricating the same are considered the most important techniques in the field of the zeolite membranes.

Conventional NaA and NaY zeolite membranes are fabricated through hydrothermal treatment by immersing a porous support having NaA or NaY zeolite seeds attached to a surface of the support into a hydrothermal solution, which is prepared by dissolving and stirring an alumina-based material, a silica-based material and sodium hydroxide in water.

That is, the conventional NaA and NaY zeolite membranes are fabricated by attaching the NaA and NaY zeolite seeds greater than an average pore size of the porous support to the surface of the supporter and immersing the support in the hydrothermal solution for hydrothermal treatment.

FIG. 1 is a SEM image of a fracture surface of a conventional zeolite membrane.

Referring to FIG. 1, it can be seen that the conventional zeolite membrane includes a support at the lowermost portion thereof and a zeolite separation layer at the uppermost portion thereof.

Since such a zeolite membrane is generally used at a process temperature greater than or equal to room temperature, the zeolite membrane inevitably undergoes a heating process, during which a zeolite separation layer is likely to suffer from thermal cracking. The reason behind this will be described with reference to the following drawings.

FIGS. 2 and 3 are cross-sectional views showing a coated state of zeolite seeds on a support of a conventional zeolite membrane and a fabricated conventional zeolite membrane, respectively.

Referring to FIG. 2, zeolite seeds 20 are coated on a surface of a support 10 and can be subjected to hydrothermal treatment to form a zeolite separation layer 30, as shown in FIG. 3.

Referring to FIG. 3, in a heating process for application of the zeolite membrane, the support 10 tends to expand and the zeolite separation layer 30 tends to contract.

Consequently, the support 10 is subjected to compressive stress and the zeolite separation layer 30 is subjected to tensile stress, so that thermal cracking occurs on the zeolite separation layer 30 when the zeolite membrane is heated.

FIGS. 4 and 5 are SEM images showing thermal cracks on a conventional NaA zeolite membrane.

Referring to FIG. 4, it can be seen that an elongated thermal crack occurs vertically on the zeolite separation layer, and FIG. 5 is an enlarged view of the thermal crack.

As mentioned above, since the target process temperature of the zeolite membrane is generally higher than room temperature, heating is inevitably performed and causes thermal cracking on the zeolite separation layer. Therefore, there is a need for a technique capable of solving this problem.

### SUMMARY OF THE INVENTION

An aspect of the invention is to provide a thermal cracking resistant zeolite membrane and a method of fabricating the same, which can exhibit stable separation characteristics at a target process temperature in a heating process while preventing the occurrence of thermal cracking on a zeolite separation layer. To this end, in fabrication of the zeolite membrane, zeolite powder having a diameter of 1˜10 μm is subjected to wet-type vibration pulverization and centrifugal separation to prepare nanosized zeolite seeds, which in turn are attached to a support. Here, the support has an average pore size greater than an average diameter of the seeds to allow the zeolite seeds to be attached not only to a surface of the support but also to an inner region of the support up to a depth corresponding to 50% of a total thickness of the support from the surface of the support.

In accordance with an aspect of the invention, there is provided a method of fabricating a thermal cracking resistant zeolite membrane through attachment of zeolite seeds to a support and hydrothermal treatment of the support to grow a zeolite separation layer, wherein the attachment of zeolite seeds includes attaching the zeolite seeds to a surface of the support while allowing the zeolite seeds to be infiltrated into the support, and the hydrothermal treatment is performed by immersing the support having the zeolite seeds into a hydrothermal solution provided to a hydrothermal reactor to grow the zeolite separation layer not only on the surface of the support but also on an inner region of the support, thereby preventing the occurrence of thermal cracking on the zeolite separation layer.

The zeolite seeds may be infiltrated into the inner region of the support ranging from a depth of 3 μm to a depth corresponding to 50% of a total thickness of the support from the surface of the support.

The zeolite separation layer may contract upon heating.

A method of fabricating a NaA zeolite membrane according to one embodiment of the invention will now be described.

The hydrothermal solution may be prepared by dissolving and stirring an alumina-based material, a silica-based material and sodium hydroxide in water. Here, the alumina-based material may include at least one selected from sodium aluminate, aluminum hydroxide, colloidal alumina, alumina powder, and aluminum alkoxide. The silica-based material may include at least one selected from water glass, sodium silicate, silica powder, colloidal silica, and silicon alkoxide.

The silicate-based material may be added in an amount such that a mole number of the silica-based material converted by silica (SiO₂) is 1˜3 times a mole number of the alumina-based material converted by alumina (Al₂O₃). The sodium hydroxide may be added in an amount such that the sum of a mole number of the sodium hydroxide converted by sodium oxide (Na₂O) and a mole number of sodium oxide (Na₂O) contained in the alumina-based material and the silica-based material is 2˜6 times a mole number of the alumina-based material converted by alumina (Al₂O₃). A mole number of water (H₂O) in the hydrothermal solution may be 400800 times the mole number of the alumina-based material converted by alumina (Al₂O₃).

The preparation of the hydrothermal solution may be carried out by dissolving the alumina-based material, the silica-based material and the sodium hydroxide in water to prepare an aqueous solution, followed by stirring the aqueous solution at 20˜80° C. for 30 minutes to 48 hours.

The zeolite seeds may be prepared through wet-type vibration pulverization and centrifugal separation of zeolite powder. Here, the zeolite powder may have a diameter of 1˜10 μm.

The zeolite seeds may have a diameter of 100˜300 nm. The zeolite seeds may be attached to the support in the form of a seed slurry comprising the seeds added in an amount of 0.0005˜0.005% by weight with respect to a total weight of water. The seed slurry may be attached to the support through vacuum filtration. The vacuum filtration may be performed for 1˜60 minutes at 1˜300 torr.

The wet-type vibration pulverization may be performed using a ceramic ball at a speed of 200˜900 cycles/min for 1˜48 hours, and the centrifugal separation may be performed at a speed of 1,000˜15,000 rpm for 1˜60 minutes.

The support may be a porous ceramic support or a porous metal support having a pore size of 0.5˜2 μm.

The hydrothermal treatment may be performed at 70˜140° C. for 12˜48 hours.

The zeolite separation layer may be formed not only on the surface of the support but also on the inner region of the support through infiltration of the seeds. The zeolite separation layer may be infiltrated into the inner region of the support ranging from a depth of 3 μm or to a depth corresponding to 50% of a total thickness of the support from the surface of the support.

In accordance with another aspect of the invention, a zeolite membrane fabricated by any one of the methods according to the invention is provided.

### BRIEF DESCRIPTION OF THE DRAWINGS

FIG. 1 is a scanning electronic microscopy (SEM) image of a fracture surface of a conventional zeolite membrane;

FIGS. 2 and 3 are cross-sectional views showing a coated state of zeolite seeds on a support of a conventional zeolite membrane and a fabricated conventional zeolite membrane, respectively;

FIGS. 4 and 5 are SEM images showing a thermal crack on a zeolite separation layer of a conventional NaA zeolite membrane;

FIGS. 6 and 7 are cross-sectional views showing a coated state of zeolite seeds on a support of a zeolite membrane and a final zeolite membrane in accordance with one embodiment of the present invention, respectively;

FIG. 8 is a SEM image of nanosized NaA zeolite seeds prepared in Example 1;

FIG. 9 is a SEM image of a fracture surface of a support used in Example 1;

FIG. 10 is a SEM image of a surface of a support used in Comparative Example 1;

FIG. 11 is a graph depicting a diameter distribution of NaA zeolite seeds and a pore size distribution of the supports used in Example 1 and Comparative Example 1;

FIG. 12 is a SEM image of a fracture surface of a NaA zeolite membrane of Example 1;

FIG. 13 is a SEM image of a fracture surface of a NaA zeolite membrane of Comparative Example 1;

FIG. 14 is a SEM image of a fracture surface of the NaA zeolite membrane of Example 1 after a thermal impact test at 150° C.;

FIG. 15 is a SEM image of a fracture surface of the NaA zeolite membrane of Comparative Example 1 after a thermal impact test at 150° C.;

FIG. 16 is a graph depicting a water/ethanol separation factor depending on time upon separation of water from a mixture of 95 wt % ethanol and 5 wt % water at 70° C. using NaA zeolite membranes of Example 1;

FIG. 17 is a graph depicting a total transmission flux depending on time upon separation of water from a mixture of 95 wt % ethanol and 5 wt % water at 70° C. using the NaA zeolite membrane of Example 1;

FIG. 18 is a graph depicting a water/ethanol separation factor depending on time upon separation of water from a mixture of 95 wt % ethanol and 5 wt % water at 70° C. using NaA zeolite membranes of Comparative Example 1;

FIG. 19 is a graph depicting a total transmission flux depending on time upon separation of water from a mixture of 95 wt % ethanol and 5 wt % water at 70° C. using the NaA zeolite membranes of Comparative Example 1; and

FIG. 20 is a graph depicting a total transmission flux depending on time as measured by rapidly flowing a 50 wt % ethanol-50 wt % water mixture preheated to several temperatures to NaA zeolite membranes of Example 1, which were at room temperature.

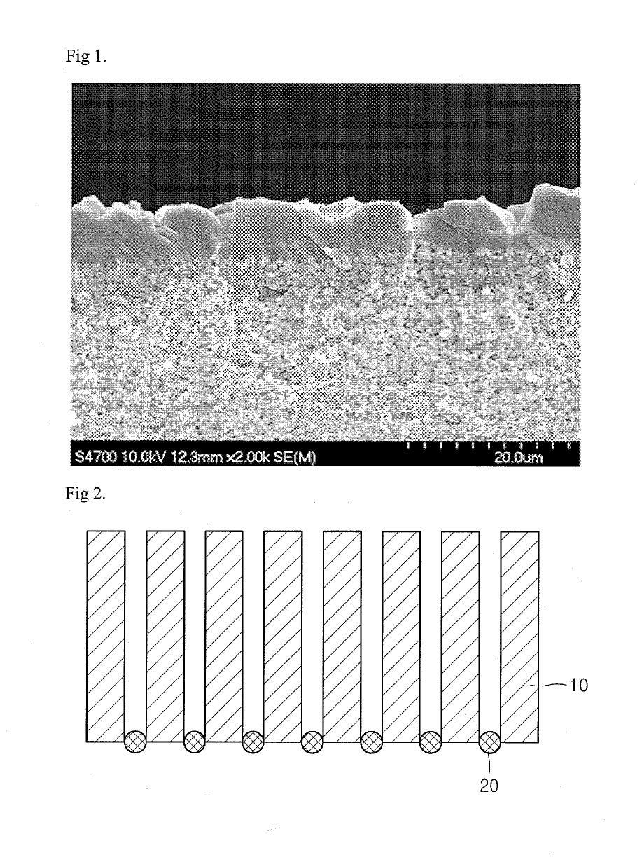

### DETAILED DESCRIPTION OF THE EMBODIMENTS

The above and other aspects, features and advantages of the invention will become apparent with reference to the following embodiments in conjunction with the accompanying drawings. Here, it should be noted that the invention is not limited to the following embodiments and may be realized in many different forms. Further, the following embodiments are given by way of illustration to provide a thorough understanding of the invention to a person having ordinary knowledge in the art, to which the invention pertains. The scope and spirit of the invention is limited only by the claims and equivalents thereof. Like elements will be denoted by like reference numerals throughout the specification.

A method of fabricating a zeolite membrane according to one embodiment of the invention will be described in brief.

First, a hydrothermal solution is prepared by dissolving water glass, sodium aluminate and sodium hydroxide in water to prepare an aqueous solution, followed by stirring the aqueous solution.

Next, zeolite seeds are attached to a porous support.

Then, the porous support having the zeolite seeds attached thereto is immersed into the hydrothermal solution received in a hydrothermal reactor to form a zeolite separation layer on the surface of the support through hydrothermal treatment, thereby synthesizing a zeolite membrane with the support coupled to the zeolite separation layer.

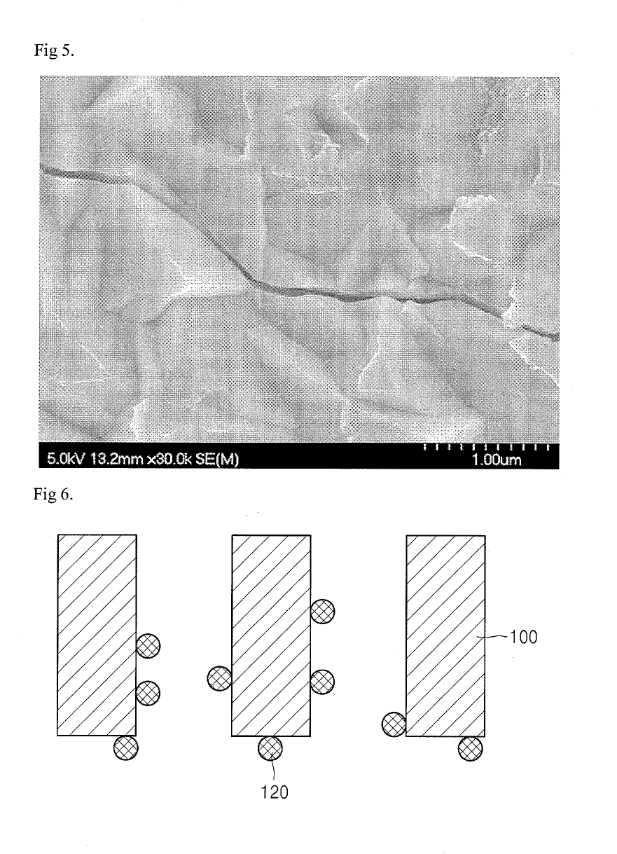

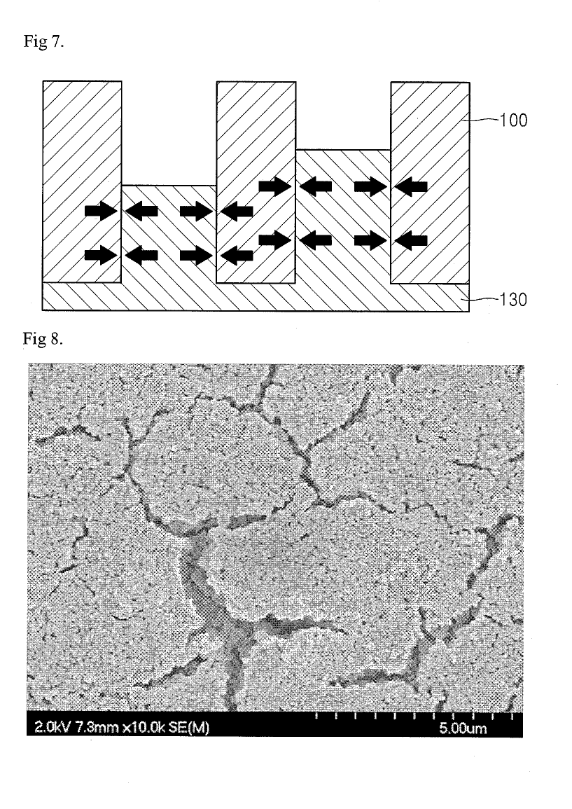

FIGS. 6 and 7 are cross-sectional views showing a coated state of zeolite seeds on a support of a zeolite membrane and a final zeolite membrane in accordance with one embodiment of the present invention, respectively.

Referring to FIG. 6, as raw materials for preparation of the zeolite membrane, water glass as a silica-based material, sodium aluminate as an alumina-based material, and sodium hydroxide are dissolved in water to prepare an aqueous solution, which in turn is subjected to stirring and aging to form a hydrothermal solution.

Next, NaA zeolite seeds 120 are attached to a porous support 100 ranging from a surface to an inner region of the porous support 100. Here, the zeolite seeds 120 may be attached to the inner region of the support 100 ranging from at least a depth of 3 μm of the support 100 to a depth corresponding to 50% of a total thickness of the support 100 from the surface of the support 100.

If the zeolite seeds 120 are attached to a region of the support 100 corresponding to a thickness less than 3 μm from the surface of the support 100, a zeolite separation layer of the zeolite membrane is concentrated on the surface of the support, thereby making it difficult to prevent thermal cracking. If the zeolite seeds 120 are attached to a region of the support 100 corresponding to a depth exceeding 50% of the total thickness of the support 100, the zeolite separation layer becomes excessively thick, thereby making it difficult to achieve good separation performance, particularly, high transmission flux.

Further, since the support has a thickness of at least 100 μm or more, the zeolite seeds may be attached up to a thickness of 50 μm or more of the support 100.

That is, when the thickness of the support is 200 μm or more, the upper limit of the thickness of the support, to which the zeolite seeds are to be attached, may become 100 μm, and when the thickness of the support is 1,000 μm, the upper limit of the thickness may become 500 μm.

Herein, the term “thickness of the support” does not refer to a line width of a bar shaped support 100 shown in the drawings, but a total height of the bar-shaped support 100. Namely, although the support is shown as having a certain line width in the drawings, the support has a porous structure in which pores are three-dimensionally connected to one another. Thus, the term “surface” and “inner region” of the support should be understood as meaning a shape into which water permeates, for example, a sponge.

Next, referring to FIG. 7, the support having the zeolite seeds attached thereto is immersed into the hydrothermal solution provided to the hydrothermal reactor and is then subjected to hydrothermal treatment to form a zeolite separation layer on the surface of the support 100, thereby forming a zeolite membrane 130.

Here, it can be seen that, since the zeolite separation layer is also formed inside the support 100, compressive stress in the support 100 is relieved by tensile stress in the zeolite separation layer.

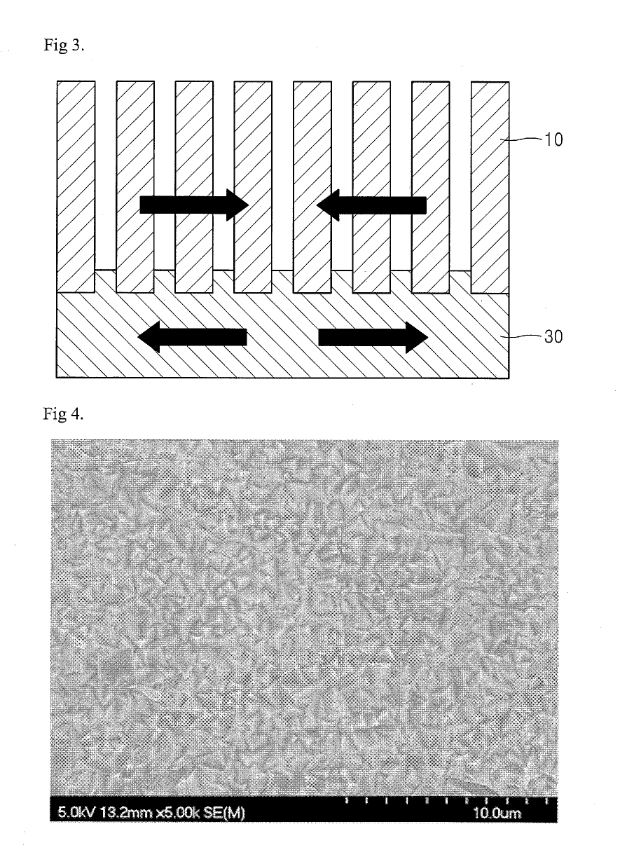

Thus, as compared with the zeolite membrane illustrated in FIG. 3, the zeolite membrane of this embodiment is prevented from thermal cracking during heating, thereby achieving improved stability.

As described above, the method of fabricating a zeolite membrane according to this invention may be easily applied for the purpose of preventing thermal cracking in a zeolite membrane, such as NaY and NaA zeolites, which contract during heating.

Next, a method of fabricating a NaZ zeolite membrane will be described in detail as one example of the method according to this invention, but it should be understood that the invention is not limited thereto.

In this method, as a raw material for preparation of the hydrothermal solution, an alumina-based material may comprise at least one selected from sodium aluminate, aluminum hydroxide, colloidal alumina, alumina powder, and aluminum alkoxide.

Further, a silica-based material may comprise at least one selected from water glass, sodium silicate, silica powder, colloidal silica, and silicon alkoxide.

Here, a SiO₂/Al₂O₃ molar ratio of silicon oxide (SiO₂) in the silica-based material to aluminum oxide (Al₂O₃) in the alumina-based material is appropriately determined depending on a composition of the NaA zeolite. Preferably, the SiO₂/Al₂O₃ molar ratio is in the range of 1 to 3, and more preferably 2. In other words, the silicate-based material may be added in an amount such that a mole number of the silica-based material converted by silica (SiO₂) is 1˜3 times that of the alumina-based material converted by alumina (Al₂O₃). If the molar ratio is less than 1, it becomes difficult to form a NaA zeolite separation layer, thereby causing deterioration in separation performance of the membrane. On the other hand, if the molar ratio exceeds 3, it also becomes difficult to form the NA zeolite separation layer and cracks are formed on the separation layer, thereby causing deterioration in separation performance of the membrane.

Next, sodium oxide (Na₂O) in the hydrothermal solution is determined by sodium oxide (Na₂O) include in the added sodium hydroxide (NaOH), silica-based material and alumina-based material. A Na₂O/Al₂O₃ molar ratio of sodium oxide (Na₂O) to aluminum oxide (Al₂O₃) in the hydrothermal solution is appropriately determined depending on a desired composition of the zeolite. Preferably, the Na₂O/Al₂O₃ molar ratio is in the range of 2 to 6, and preferably 4.5.

That is, the sodium hydroxide may be added in an amount such that the sum of a mole number of sodium hydroxide converted by sodium oxide (Na₂O) and a mole number of sodium oxide (Na₂O) contained in the alumina-based material and the silica-based material is 2˜6 times that of the alumina-based material converted by aluminum oxide (Al₂O₃).

If the molar ratio is less than 2, it becomes difficult to form the NaA zeolite separation layer, thereby causing deterioration in separation performance of the membrane. If the molar ratio exceeds 6, the NaA zeolite separation layer becomes thick and non-uniform, thereby causing deterioration in separation performance of the membrane.

Water (H₂O) in the hydrothermal solution is determined by water contained in the aqueous solution of silica-based material, alumina-based material and sodium hydroxide. A H₂O/Al₂O₃ molar ratio of water (H₂O) to aluminum oxide (Al₂O₃) in the hydrothermal solution is appropriately determined depending on a desired composition of the zeolite, the H₂O/Al₂O₃ molar ratio may be in the range of 400 to 800, and preferably 600.

Next, during the preparation of the hydrothermal solution by stirring the aqueous solution, the aqueous solution may be maintained at 20˜80° C. for 30 minutes to 48 hours. If the aqueous solution is maintained at a temperature less than 20° C. for less than 30 minutes, the zeolite membrane may suffer from deterioration in separation performance, and if the aqueous solution is maintained at a temperature above 80° C. for more than 8 hours, it can become difficult to obtain a uniform zeolite membrane.

Next, the support has zeolite seeds having a particle size of 100˜300 nm attached to the surface thereof. Here, the reason of attaching the zeolite seeds to the support is to coat the support with the zeolite seeds in such a way of growing the zeolite seeds on the support.

If the zeolite seeds have a particle size less than 100 nm, the zeolite seeds are likely to pass through the porous support instead of being attached to the support due to too small a particle size, so that the zeolite seeds are insufficiently attached to the support. If the zeolite seeds have a particle size more than 300 nm, the zeolite seeds are unevenly attached to the surface of the support, thereby making it difficult to form a uniform zeolite separation layer. Further, since the zeolite separation layer is formed on the surface of the support, thermal cracking is likely to occur thereon.

The support to which the zeolite seeds will be attached may be selected from a porous ceramic support and a porous metal support. The ceramic support may be made of mullite, alumina, silica, titania, zirconia, silicon carbide, etc, and the metal support may be made of stainless steel, sintered nickel, a mixture of sintered nickel and iron, or the like. As for the material of the support, a ceramic material, particularly, alumina is preferred in view of difficulty of elution in a liquid.

The support to which the zeolite seeds will be attached may have an average pore size of 0.5˜2 μm. If the average pore size of the support is less than 0.5 μm, it is difficult for the zeolite seeds having a particle diameter of 100˜300 nm to be attached into micropores of the porous support, thereby causing thermal cracking on the zeolite separation layer formed on the support.

If the average pore size of the support exceeds 2 μm, the seeds pass through the support instead of being attached to the surface and inner region of the support, thereby making it difficult to form a zeolite separation layer free of defects such as pin-holes.

The support to which the zeolite seeds will be attached may have a porosity of 20˜50%, and preferably 35˜45%. If the porosity of the support is less than 20%, the transmission rate tends to decrease, so that the transmission flux is lowered. On the other hand, if the porosity of the support exceeds 50%, self-supportability (mechanical strength) of the support tends to be lowered. Accordingly, when the porosity of the support is in the range of 35˜45%, it is possible to obtain a zeolite membrane, transmission flux and self-supportability of which are sufficiently high.

Further, the support to which the zeolite seeds will be attached may have a variety of shapes including a pipe shape, a barrel shape, a hollow yarn shape, a plate shape, a multi-pipe monolith shape, a honeycomb shape, and a pellet shape. The shape of the support may be suitably determined in consideration of desired use and processing capacity of the NaA zeolite membrane.

The zeolite seeds may be prepared to have an average diameter of 100˜300 nm through wet-type vibration pulverization and centrifugal separation of 1˜10 μm NaA zeolite powder. If the average diameter of the zeolite seeds is less than 100 nm, it is difficult to secure a NaA zeolite separation layer of a uniform and desired thickness due to an insufficient amount of zeolite seeds being attached to the surface and inner region of the porous support. If the average diameter of the zeolite seeds exceeds 300 nm, the NaA zeolite separation layer can be separated from the support or become uneven thereon and can suffer from thermal cracking due to excess zeolite seeds attached to the surface of the support.

In preparation of the zeolite seeds, the wet-type vibration pulverization may be performed using a vibration pulverizer, in which 1˜10 μm NaA zeolite powder is placed together with a ceramic ball and water, at a speed of 200˜900 cycles/min for 1˜48 hours, and preferably at a speed of 500 cycles/min for 28 hours. Here, a weight ratio of NaA zeolite powder:ceramic ball:water may be 1:90:20, and a batch size is fixed to 20 ml of water in this invention.

The ceramic ball may be made of silicon carbide, silicon nitride, alumina, zirconia, or the like. Advantageously, the ceramic ball may be made of alumina, which is a component of the zeolite, and the alumina ball may have a diameter of about 1 mm.

Further, in preparation of the zeolite seeds, the centrifugal separation may be performed at a speed of 1,000˜15,000 rpm for 1˜60 minutes, and preferably 6,000 rpm for 10 minutes. The centrifugal separation is performed for the purpose of selectively removing relatively large particles from a high concentration slurry, which is obtained by the wet-type vibration pulverization. Thus, the zeolite seeds are in an evenly distributed state after the centrifugal separation and are then diluted with water to have a total volume of 200 ml to preserve the zeolite seeds for subsequent use. Here, the zeolite seeds have a weight of 0.1 wt % in a seed preserving slurry.

Attaching the seeds to the support may be performed by dip-coating (a method of dipping a support in seeds), spray coating (a method of spraying seeds to a porous support), or filtration (a method of passing seeds through a porous support), and preferably vacuum filtration (a method of filtering seeds through a porous support in a vacuum).

Here, the seeds used in the vacuum filtration are prepared in the form of a seed slurry by diluting the seed preserving slurry with water again. The weight of seeds may be adjusted by changing the weight of the seed preserving slurry to be diluted with water. Preferably, the weight of seeds is in the range of 0.0005˜0.005 wt %, and more preferably 0.0026 wt % with respect to the total weight of water.

Further, the vacuum filtration may be performed at a pressure of 1˜300 ton for 1˜60 minutes, and preferably 150 torr for 20 minutes.

After the zeolite seeds are attached to the support, the support and the zeolite seeds attached thereto may be dried. That is, adhesion of the zeolite seeds to the support may be further enhanced by drying the support and zeolite seeds. Drying may be performed at a temperature of 70˜120° C.

The hydrothermal treatment may be performed at 70˜140° C. for 12˜48 hours. If the hydrothermal treatment is performed at a temperature less than 70° C. or for less than 12 hours, the NaA zeolite membrane cannot be sufficiently formed, thereby causing deterioration in separation performance. If the hydrothermal treatment is performed at a temperature exceeding 140° C. for more than 48 hours, an undesired zeolite phase or zeolite separation layer can be formed on the surface of the NaA zeolite membrane or the zeolite membrane can be thickened to cause thermal cracking, thereby deteriorating separation performance.

As such, the NaA zeolite membrane according to the invention may be easily fabricated by the processes described above. Conventionally, zeolite seeds having a relatively large size of 1˜10 μm or formed of expensive raw materials are processed into nanosized seeds through a precisely controlled process to fabricate a NaA zeolite membrane.

In this invention, however, a thermal cracking resistant NaA zeolite membrane may be stably fabricated by preparing nano-sized zeolite seeds in the faun of a slurry through a reliable, inexpensive and simple process and attaching the prepared zeolite seeds to an inner region of the support corresponding to 50% of the total thickness of the support.

Next, the NaA zeolite membrane according to the invention will be described in more detail with reference to an example and a comparative example.

### Example 1

Water glass, sodium aluminate and sodium hydroxide (NaOH) were dissolved in water to produce an aqueous solution, which in turn was stirred at 28° C. for 24 hours, thereby preparing a hydrothermal solution. The hydrothermal solution has a total volume of 500 ml, and mole numbers of Al₂O₃, SiO₂, Na₂O, and H₂O in the hydrothermal solution are 1, 2, 4.5, and 600, respectively.

1 g of a NaA zeolite powder was subjected to wet-type vibration pulverization using 20 g water and a 90 g alumina ball 1 mm in diameter at 500 cycles/min for 24 hours, centrifugal separation at 6,000 rpm for 10 minutes, and dilution with 200 g water to prepare a 0.1 wt %-seed preserving slurry. 4 ml of the seed preserving slurry was extracted and diluted with 150 g water to prepare seeds having a weight of 0.0026 wt %. The prepared seeds have an average diameter of 0.15 in (150 nm), and a detailed shape of the seeds is shown in FIG. 8.

FIG. 8 is a SEM image of nanosized NaA zeolite seeds prepared in Example 1.

Referring to FIG. 8, it can be seen that the seeds of Example 1 have an average diameter of 150 nm.

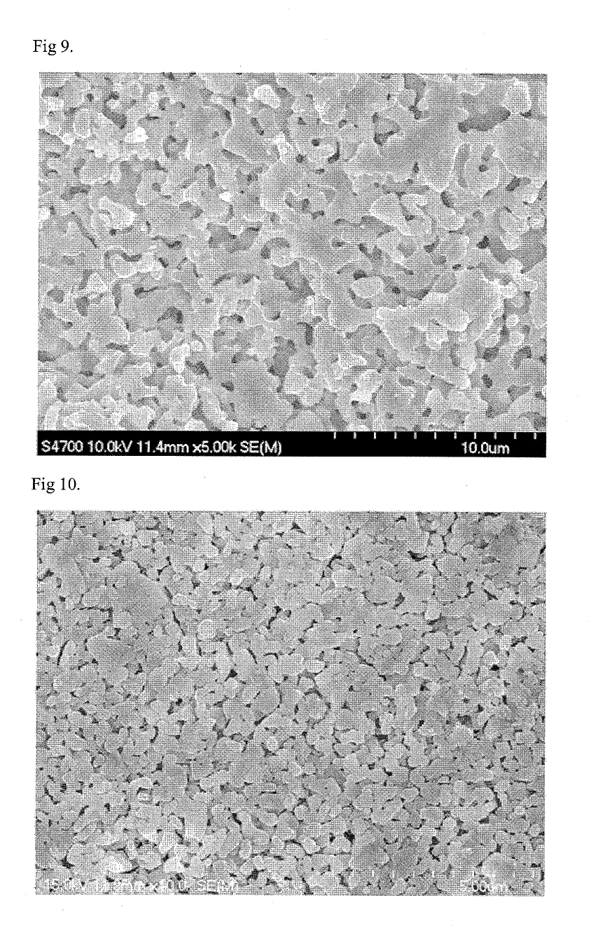

Next, the seeds were implanted from an outer surface of a tube-shaped Si—Al—Na—O glass support, which has an outer diameter of 7.8 mm, an inner diameter of 5 mm, a length of 40 cm and an average thickness of 1,400 μm, to a depth of 100 μm. Attaching the seeds to the support was performed at an inner pressure of 150 ton for 20 minutes. Then, the seeds and the support were dried at 100° C. for 12 hours, thereby providing the support having the seeds attached thereto. Here, the support had an average pore size of 0.65 μm and a porosity of 42.3%. A detailed fracture surface of the support is shown in FIG. 9.

FIG. 9 is a SEM image of a fracture surface of the support used in Example 1.

In FIG. 9, a SEM image of a fracture surface of the Si—Al—Na—O glass support is shown.

Next, the support having the seeds attached thereto was dipped into a 400 ml hydrothermal synthesizer receiving 330 ml of the hydrothermal solution, followed by hydrothermal treatment at 100° C. for 24 hours with the hydrothermal synthesizer closed, washing five times and drying, thereby providing NaA zeolite membranes.

### Comparative Example 1

NaA zeolite membranes of Comparative Example 1 were prepared through the same processes as those of Example 1, that is, the processes of preparing a hydrothermal solution and seeds, coating and drying the seeds on a support, dipping the support into the hydrothermal solution, hydrothermal treatment, washing, and drying.

The support of Comparative Example 1 is different from Example 1. In Comparative Example 1, the support was a tube-shaped alpha-alumina support having an outer diameter of 7.3 mm, an inner diameter of 5 mm, a length of 40 cm, and an average thickness of 750 μm. The support had an average pore size of 0.12 μm and a porosity of 33.6%.

FIG. 10 is a SEM image of a surface of the support of Comparative Example 1.

In FIG. 10, since the surface of the alpha-alumina support had too small an average pore size, specifically, less than 0.5 μm, that is, a preferable average pore size of this invention, the seeds were attached to a depth less than 3 μm from the surface of the support.

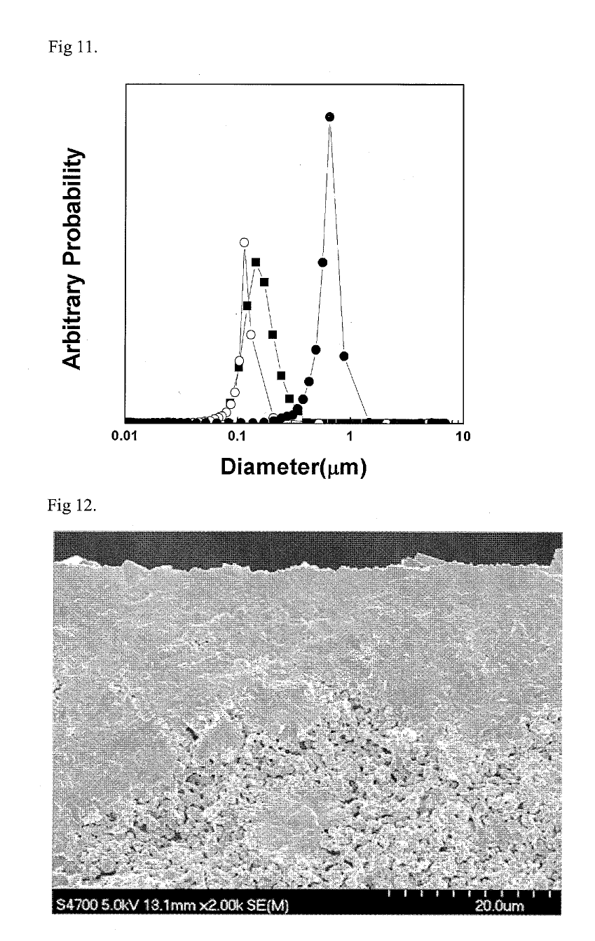

This phenomenon can be anticipated from FIG. 11, and will be described in more detail hereinafter. Here, the average pore size of the support was measured using a mercury porosimeter and the average particle diameter of the seeds was evaluated by a laser scattering method.

Referring to FIG. 11, a pore size distribution of the support used in Example 1 is represented by -- and shows that a distribution of 0.65 μm has the highest value.

Next, a pore size distribution of the support used in Comparative Example 1 is represented by -◯- and shows that a distribution of 0.12 μm has the highest value.

Further, a particle diameter distribution of seeds is represented by -▪- and shows that a distribution of 0.15 μm has the highest value.

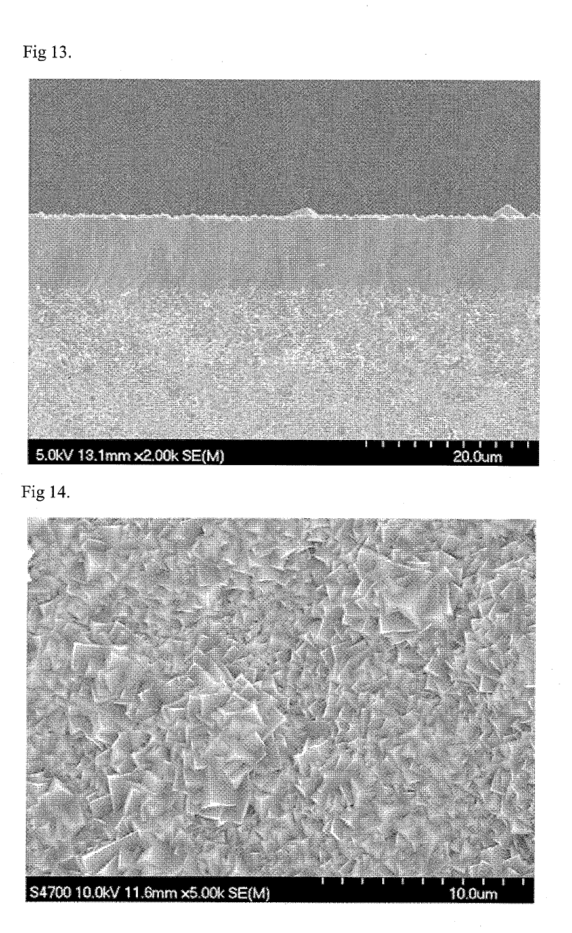

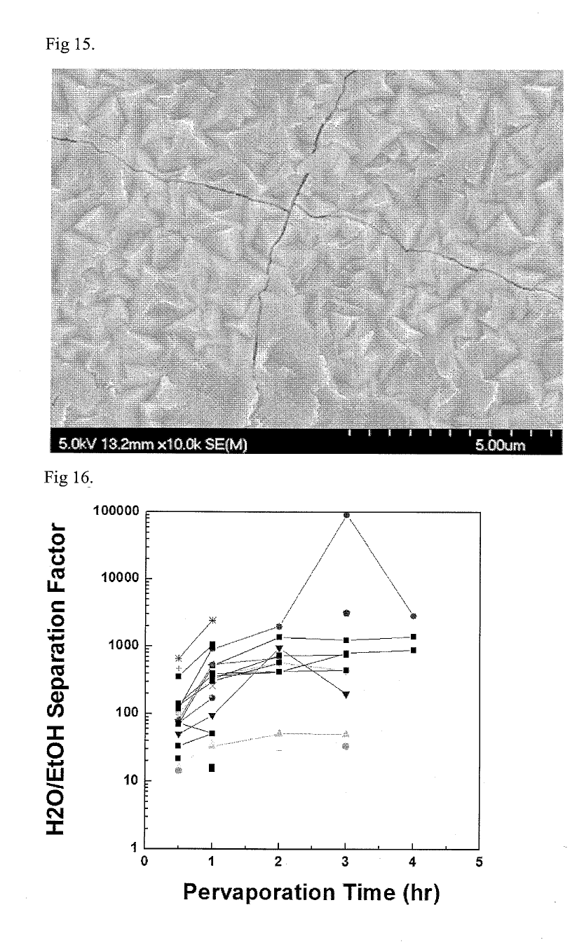

It could be seen that the zeolite membrane of Comparative Example 1 had a zeolite separation layer concentrated on the surface of the support, as shown in FIG. 13. This result means that Comparative Example 1 represents a conventional method. Consequently, thermal cracking occurred as shown in FIG. 15. As compared with Comparative Example 1, however, the zeolite membrane prepared by Example 1 did not suffer from thermal cracking.

These results were obtained by the following evaluations, which will be described below in more detail.

[Microstructure]

Microstructures of the NaA zeolite membranes of Example 1 and Comparative Example 1 were evaluated by observing fracture surfaces using a SEM. The location and shape of a NaA zeolite separation layer formed on each membrane were evaluated depending on an aspect of the fracture surface.

[Thermal Impact Stability]

Thermal impact stability of the NaA zeolite membranes of Example 1 and Comparative Example 1 was evaluated depending on whether thermal cracking occurred on a surface of each membrane by observing the microstructure of the surface using a SEM. Here, the microstructure of the membrane surface was observed after rapidly introducing the NaA zeolite membrane at room temperature into an oven pre-heated to 150° C. and maintaining the membrane therein for 3 hours.

[Separation Factor]

Separation performance of the NaA zeolite membranes of Example 1 and Comparative Example 1 were evaluated based upon a separation factor. For example, in the case of separating a mixture of water and ethanol into water and ethanol, it is assumed that the concentration of water in the mixture before separation is A1 mol %, the concentration of ethanol in the mixture before separation is A2 mol %, and the concentrations of water and ethanol in a liquid or gas transmitting through a NaA zeolite membrane are B1 mol % and B2 mol %, respectively. In this case, the separation factor is expressed by (B1/B2)/(A1/A2).

It can be deduced that a higher separation factor leads to better separation performance and less defect on a membrane.

[Transmission Flux]

Water transmission flux through the NaA zeolite membranes of Example 1 and Comparative Example 1 were evaluated based upon the total transmission flux and the concentration of a transmitted material. The term “transmission flux” refers to the amount of liquid or gas transmitting through a NaA zeolite membrane per unit time and per area. It can be deduced that a zeolite membrane having a higher transmission flux along with a higher separation factor provides superior practicability.

Evaluation of the zeolite membranes may be categorized into these four methods, and the microstructure of the zeolite membranes will be described first.

FIG. 12 is a SEM image of a fracture surface of the NaA zeolite membrane of Example 1, and FIG. 13 is a SEM image of a fracture surface of the NaA zeolite membrane of Comparative Example 1.

Referring to FIGS. 12 and 13, it can be ascertained that the NaA zeolite membrane of Example 1 has the zeolite separation layer not only on the surface of the support but also on the inner region of the support, whereas the NaA zeolite membrane of Comparative Example 1 has the zeolite separation layer only on the surface of the support. That is, it can be seen that the NaA zeolite membrane of Example 1 has a distinctively different microstructure from the NaA zeolite membrane of Comparative Example 1.

Next, microstructure on surfaces of NaA zeolite membranes obtained from the NaA zeolite membranes of Example 1 and Comparative Example 1 after a thermal impact test at 150° C. will be described.

FIG. 14 is a SEM image of a fracture surface of the NaA zeolite membrane of Example 1 after a thermal impact test at 150° C., and FIG. 15 is a SEM image of a fracture surface of the NaA zeolite membrane of Comparative Example 1 after a thermal impact test at 150° C.

Referring to FIGS. 14 and 15, it can be ascertained that thermal cracking is not observed on the zeolite separation layer of the NaA zeolite membrane of Example 1 after the thermal impact test, whereas the thermal cracking is observed on the zeolite separation layer of the NaA zeolite membrane of Comparative Example 1 after the thermal impact test. That is, it can be ascertained that the NaA zeolite membrane of Example 1 has better thermal impact resistance than the NaA zeolite membrane of Comparative Example 1.

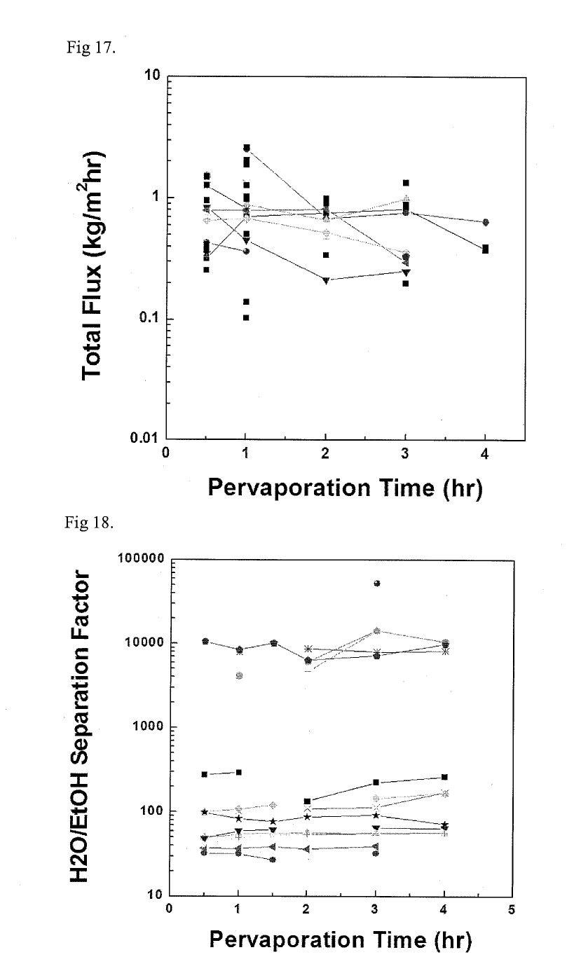

Next, FIG. 16 is a graph depicting a water/ethanol separation factor depending on time upon separation of water from a mixture of 95 wt % ethanol and 5 wt % water at 70° C. using NaA zeolite membranes of Example 1, and FIG. 17 is a graph depicting a total transmission flux depending on time upon separation of water from a mixture of 95 wt % ethanol and 5 wt % water at 70° C. using the NaA zeolite membranes of Example 1.

Referring to FIGS. 16 and 17, for most of the zeolite membranes, the water/ethanol separation factor increases over time during the evaluation and is 1000 after 1 hour. On the other hand, the transmission flux decreases over time and is about 0.1˜1 kg/m² hr.

Here, since an individual explanation of each line does not have a critical significance in this invention, a detailed description thereof will be omitted and characteristics of the lines will be described in consideration of an overall pattern. In addition, a detailed description of a line in each graph described below will also be omitted.

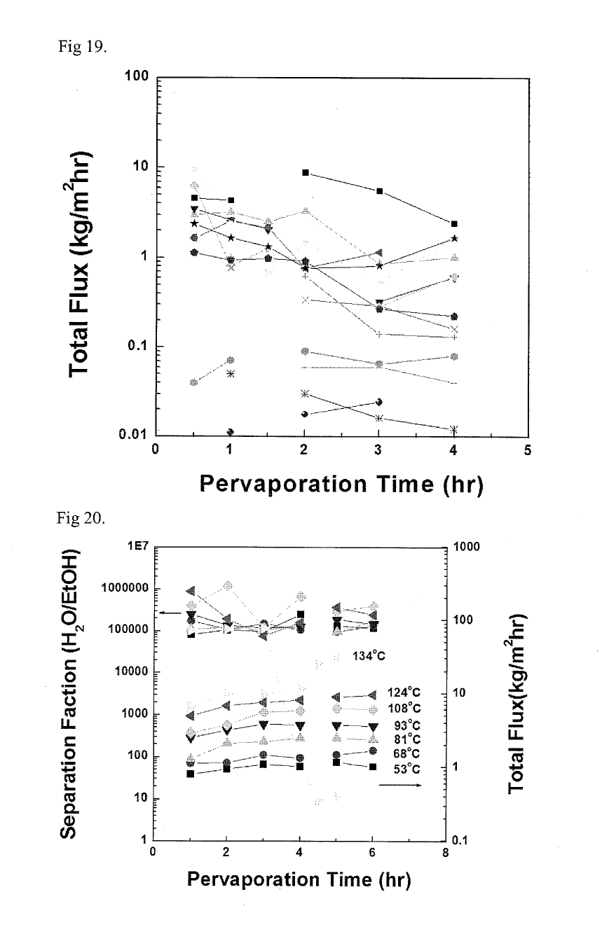

Next, FIG. 18 is a graph depicting a water/ethanol separation factor depending on time upon separation of water from a mixture of 95 wt % ethanol and 5 wt % water at 70° C. using NaA zeolite membranes of Comparative Example 1, and FIG. 19 is a graph depicting a total transmission flux depending on time upon separation of water from a mixture of 95 wt % ethanol and 5 wt % water at 70° C. using the NaA zeolite membranes of Comparative Example 1.

Referring to FIGS. 18 and 19, most of the zeolite membranes prepared by Comparative Example 1 have a low water/ethanol separation factor of about 100 or less, and some zeolite membranes prepared by Comparative Example 1 have a high water/ethanol separation factor of about 10,000.

Further, most of the zeolite membranes prepared by Comparative Example 1 have a total transmission rate of about 1˜10 kg/m² hr at an initial stage, and the zeolite membranes having a high water/ethanol separation factor of about 10000 in FIG. 18 have a very low total transmission rate of about 0.1 kg/m² hr.

In addition, when observing the microstructure of a zeolite membrane having a high transmission rate of 1 kg/m² hr and a low separation factor of about 100 or less at 70° C., it can be ascertained that well developed cracks are present on a separation layer of the zeolite membrane. It can be deduced that this phenomenon appears due to the occurrence of thermal cracks during heating to 70° C. for evaluation of separation performance.

From the results illustrated in FIGS. 14 to 19, it can be ascertained that the NaA zeolite membranes of Example 1 have superior thermal stability to the NaA zeolite membranes of Comparative Example 1 provided as a conventional technique.

In addition, separation factors and total transmission fluxes of the zeolite membranes prepared in Example 1 depending on temperature were tested, and the test results are shown in FIG. 20.

FIG. 20 is a graph depicting a total transmission flux depending on time as measured by rapidly flowing a 50 wt % ethanol-50 wt % water mixture preheated to several temperatures to NaA zeolite membranes of Example 1, which were at room temperature.

That is, the test was performed by abruptly providing the 50 wt % ethanol-50 wt % water mixture, which had already been preheated to a target temperature, to the NaA zeolite membranes of Example 1, which were at room temperature.

Referring to FIG. 20, the zeolite membranes of Example 1 fail to withstand then stress at 134° C. and thermal cracks are created therein, thereby causing a rapid decrease in water/ethanol separation factor and a rapid increase in total transmission flux of the zeolite membranes.

This can be compared with the zeolite membranes of Comparative Example 1 in FIGS. 16 and 17. Many zeolite membranes of Comparative Example 1 as a conventional technique suffer thermal cracks at a low temperature of 70° C., whereas the zeolite membranes of Example 1 are thermally stable up to about 130° C.

Accordingly, the method of fabricating a NaA zeolite membrane according to this invention may provides a desired thermal cracking resistant zeolite membrane.

As such, in the method according to the embodiment, nanosized zeolite seeds are attached not only to a surface of a support but also to an inner region of the support such that a zeolite separation layer is formed not only on the surface of the support but also on the inner region of the support, thereby preventing the occurrence of thermal cracking on the zeolite separation layer of the zeolite membrane.

Accordingly, the zeolite membrane may continue to exhibit stable and superior separation performance during heating to a target process temperature or at the target process temperature.

Further, in the method according to the embodiment, the nanosized zeolite seeds are obtained through wet-type vibration pulverization and centrifugal separation, thereby reducing manufacturing costs and time while improving reliability, as compared with a conventional method for preparing nano-sized zeolite seeds.

Although some embodiments have been provided to illustrate the invention, it will be apparent to those skilled in the art that the embodiments are given by way of illustration only, and that various modifications, changes, alterations, and equivalent embodiments can be made without departing from the spirit and scope of the invention. The scope of the invention should be limited only by the accompanying claims.

What is claimed is:

1. A method of fabricating a thermal cracking resistant zeolite membrane through attachment of zeolite seeds to a support and hydrothermal treatment of the support to grow a zeolite separation layer,
wherein the attachment of zeolite seeds includes attaching the zeolite seeds to a surface of the support while allowing the zeolite seeds to be infiltrated into the support, and the hydrothermal treatment is performed by immersing the support having the zeolite seeds into a hydrothermal solution provided to a hydrothermal reactor to grow the zeolite separation layer not only on the surface of the support but also on an inner region of the support, thereby preventing the occurrence of thermal cracking on the zeolite separation layer.

2. The method according to claim 1, wherein the zeolite seeds is infiltrated into the inner region of the support ranging from a depth of 3 μm to a depth corresponding to 50% of a total thickness of the support from the surface of the support.

3. The method according to claim 1, wherein the zeolite separation layer contracts upon heating.

4. The method according to claim 1, wherein the hydrothermal solution is prepared by dissolving and stirring an alumina-based material, a silica-based material and sodium hydroxide in water.

5. The method according to claim 4, wherein the alumina-based material comprises at least one selected from sodium aluminate, aluminum hydroxide, colloidal alumina, alumina powder, and aluminum alkoxide.

6. The method according to claim 4, wherein the silica-based material comprises at least one selected from water glass, sodium silicate, silica powder, colloidal silica, and silicon alkoxide.

7. The method according to claim 4, wherein the silicate-based material is added in an amount such that a mole number of the silica-based material converted by silica (SiO₂) is 1˜3 times that of the alumina-based material converted by alumina (Al₂O₃).

8. The method according to claim 4, wherein the sodium hydroxide is added in an amount such that the sum of a mole number of the sodium hydroxide converted by sodium oxide (Na₂O) and a mole number of sodium oxide (Na₂O) contained in the alumina-based material and the silica-based material is 2˜6 times a mole number of the alumina-based material converted by alumina (Al₂O₃).

9. The method according to claim 4, wherein a mole number of water (H₂O) in the hydrothermal solution is 400˜800 times that of the alumina-based material converted by alumina (Al₂O₃).

10. The method according to claim 4, wherein the preparation of the hydrothermal solution is carried out by dissolving the alumina-based material, the silica-based material and the sodium hydroxide in water to prepare an aqueous solution, followed by stirring the aqueous solution at 20˜80° C. for 30 minutes to 48 hours.

11. The method according to claim 1, wherein the zeolite seeds are prepared through wet-type vibration pulverization and centrifugal separation of zeolite powder.

12. The method according to claim 11, wherein the zeolite powder has a diameter of 1˜10 μm.

13. The method according to claim 11, wherein the zeolite seeds have a diameter of 100˜300 nm.

14. The method according to claim 11, wherein the zeolite seeds are attached to the support in the form of a seed slurry comprising the seeds added in an amount of 0.0005˜0.005% by weight with respect to a total weight of water.

15. The method according to claim 14, wherein the seed slurry is attached to the support through vacuum filtration.

16. The method according to claim 15, wherein the vacuum filtration is performed for 1˜60 minutes at 1˜300 torr.

17. The method according to claim 11, wherein the wet-type vibration pulverization is performed using a ceramic ball at a speed of 200˜900 cycles/min for 1˜48 hours.

18. The method according to claim 11, wherein the centrifugal separation is performed at a speed of 1,000˜45,000 rpm for 1˜60 minutes.

19. The method according to claim 1, wherein the support is a porous ceramic support or a porous metal support having a pore size of 0.5˜2 μm.

20. The method according to claim 1, wherein the hydrothermal treatment is performed at 70˜140° C. for 12˜48 hours.

21. The method according to claim 1, wherein the zeolite separation layer is formed not only on the surface of the support but also on the inner region of the support through infiltration of the seeds.

22. The method according to claim 21, wherein the zeolite separation layer is infiltrated into the inner region of the support ranging from a depth of 3 μm to a depth corresponding to 50% of a total thickness of the support from the surface of the support.

23. A zeolite membrane fabricated by the method according to claim 1.
